(19) United States
(12) Patent Application Publication
(10) Pub. No.: US 2004/0155989 A1
(43) Pub. Date: Aug. 12, 2004

(54) Panel device for video

(76) Inventor: Ken Tamagawa, Kanagawa (JP)

Correspondence Address: FISH & RICHARDSON P.C., 1425 K STREET, N.W., 11TH FLOOR, WASHINGTON, DC, 20005-3500, US

(21) Appl. No.: 10/481,036

(22) PCT Filed: Nov. 13, 2001
(86) PCT No.: PCT/JP01/09912

(51) Int. Cl. H04N 5/65

(52) U.S. Cl. 348/818; 348/823

(57) ABSTRACT

The present invention relates to a video panel apparatus that can be housed in a video rack placed in a studio such as a broadcasting studio or a production studio. The video panel apparatus 1 comprises a frame base 2, a panel frame 3 pivotably provided on the frame base 2 and mainly provided with a display part and a control part 33, and angle adjusting means 4 for adjusting the tilt angle of the panel frame 3 with respect to the frame base 2. The angle adjusting means 4 includes a pivoting part 40 having a plurality of notched grooves 42, and an engaging part 41 selectively engageable with any of the notched grooves 42 of the pivoting part 40, whereby the tilt angle can be adjusted stepwise.

### TECHNICAL FIELD

The present invention relates to a video panel apparatus that can be housed in a video rack placed in a studio such as a broadcasting studio or a production studio.

### BACKGROUND ART

A video rack is placed in a studio such as a broadcasting studio or a production studio. The video rack houses a video panel apparatus and so forth. The video panel apparatus comprises mainly a frame base and a panel frame. More specifically, the frame base is formed in the shape of a frame, the top of which is open. An electrical appliance for video and so forth are mounted on the bottom of the frame base. The frame base is provided in the video rack in such a manner that the top of the frame base is located at the front side of the video rack, and the frame base bottom equipped with the electrical appliance for video and so forth is positioned at the back side of the video rack. The panel frame is secured to the top side of the frame base. The panel frame is mainly provided with a display part, e.g. a video monitor, and a control part including control buttons and so forth. The control part is provided in the vicinity of the display area of the display part.

The display part is pivotably mounted on the panel frame so that a user can see the display area of the display part from a desired angle. That is, the angle of the display area of the display part can be changed to a desired angle with respect to the panel frame. When the display part is a liquid crystal monitor, in particular, the user can clearly view the display area only within the range of viewing angles. Therefore, it is useful that the display part is pivotably attached to the panel frame.

However, the conventional video panel apparatus is incapable of changing the angle of the control part, which is provided in the vicinity of the display area of the display part, although it allows the angle of the display area of the display part to be changed to a desired angle. This is inconvenient for the user.

The present invention was made in view of the above-described problems with the prior art, and an object of the present invention is to provide a video panel apparatus allowing both the display area of the display part and the control part to be simultaneously changed in angle as one unit, thereby improving convenience and controllability for the user.

### DISCLOSURE OF INVENTION

The present invention provides a video panel apparatus comprising a frame base, a panel frame pivotably provided on the frame base, and angle adjusting means for adjusting the tilt angle of the panel frame with respect to the frame base.

The angle adjusting means may include a pivoting part having a plurality of notched grooves, and an engaging part selectively engageable with any of the notched grooves of the pivoting part, whereby the tilt angle can be adjusted stepwise.

The arrangement may be such that the pivoting part is provided on the frame base, and the engaging part is provided on the panel frame.

Further, the arrangement may be such that the pivoting part is provided on the panel frame, and the engaging part is provided on the frame base.

The engaging part may be formed at the distal end of a plate spring.

Further, the engaging part may be formed at the distal end of a plunger.

The panel frame may be provided with a display part and a control part, so that both the display part and the control part are simultaneously adjusted as one unit in terms of the tilt angle with respect to the frame base when the tilt angle of the panel frame with respect to the frame base is adjusted by the angle adjusting means.

The display part may have a video monitor.

The video monitor may be a liquid crystal monitor.

The control part may have a pushbutton.

Further, force with which the engaging part engages any of the notched grooves may be set larger than external force applied to the control part when a user actuates the control part.

The tilt angle adjusted by the angle adjusting means may be in the range of from −10 degrees to 10 degrees.

Further, the tilt angle adjusted by the angle adjusting means may be zero degree.

### BRIEF DESCRIPTION OF THE DRAWINGS

FIG. 1 is a plan view showing an embodiment of the video panel apparatus according to the present invention.

FIG. 2 is a fragmentary transverse sectional view showing the embodiment.

FIG. 3 is a plan view showing the embodiment.

FIG. 4 is a plan view showing the embodiment.

FIG. 5 is a fragmentary transverse sectional view showing another embodiment.

FIG. 6 is a fragmentary transverse sectional view showing still another embodiment.

### EMBODIMENTS OF THE INVENTION

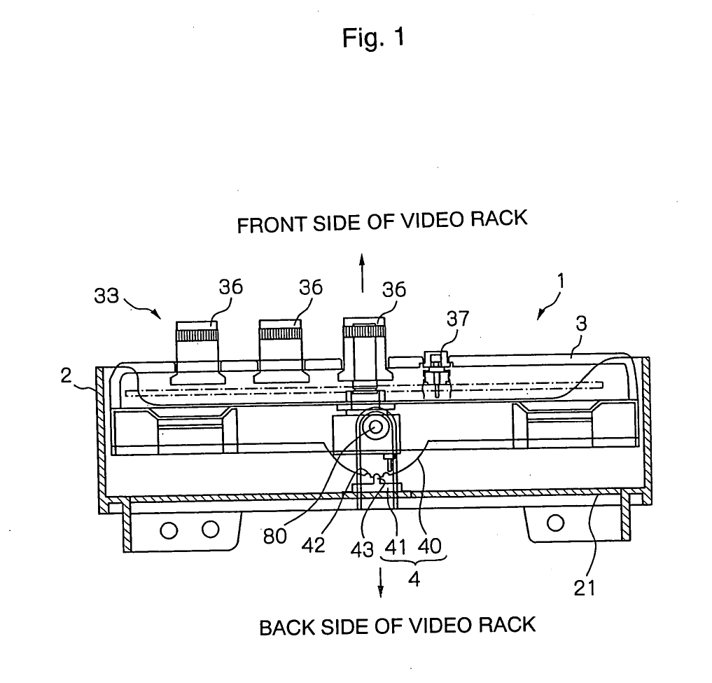

An embodiment of the video panel apparatus according to the present invention will be described below with reference to the accompanying drawings. In FIG. 1, reference numeral 1 denotes a video panel apparatus according to the present invention. As shown in FIG. 1, the video panel apparatus 1 comprises mainly a frame base 2 and a panel frame 3 pivotably provided on the frame base 2. The video panel apparatus 1 further includes an angle adjusting means 4 for adjusting the tilt angle of the panel frame 3 with respect to the frame base 2.

More specifically, the frame base 2 has the shape of a frame, the top of which is open. The frame base 2 has an electrical appliance for video and so forth (not shown) mounted on the outside of the bottom 21 thereof. The frame base 2 is provided in a video rack in such a manner that the top of the frame base 2 is located at the front side of the video rack, and the bottom 21 equipped with the electrical appliance for video and so forth is positioned at the back side of the video rack.

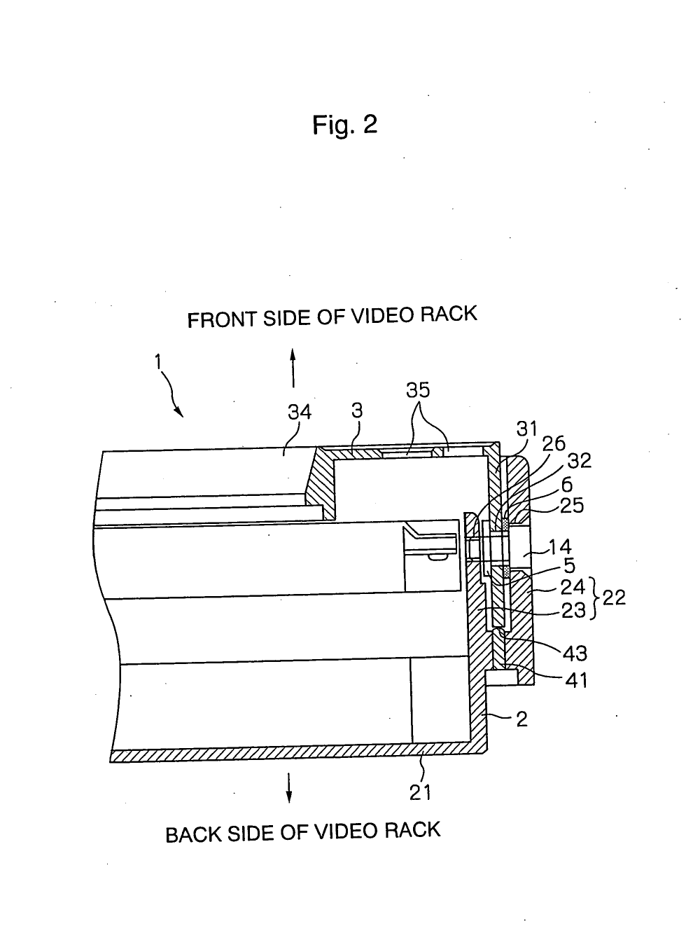

The frame base 2 has the panel frame 3 pivotably attached to the top side thereof. As shown in FIG. 2, a side 22 of the frame base 2 is formed in a double-wall structure from an inner plate 23 and an outer plate 24. The width between the inner plate 23 and the outer plate 24 is larger than the wall thickness of a side plate 31 of the panel frame 3. The side plate 31 of the panel frame 3 is interposed between the inner plate 23 and the outer plate 24. An insertion opening 25 is formed in the center (the position indicated by reference numeral 80 in FIG. 1) of the outer plate 24. The head of a screw 14 is inserted in the insertion opening 25. The head of the screw 14 functions as a pivot shaft. The inner plate 23 has a tapped hole 26 formed at a position corresponding to the insertion opening 25. The threaded portion of the screw 14 is engaged in the tapped hole 26. Further, the side plate 31 of the panel frame 3 has a through-opening 32 formed at a position corresponding to the insertion opening 25 and the tapped hole 26. A bushing 5 is interposed between the inner plate 23 and the side plate 31. A washer 6 is interposed between the outer plate 24 and the side plate 31. The threaded portion of the screw 14 extends through the insertion opening 25, the washer 6, the through-opening 32 and the bushing 5 to engage the tapped hole 26. Thus, the panel frame 3 is mounted on the top side of the frame base 2 so as to be pivotable about the screw 14. It should be noted that FIG. 2 shows only one side 22 of the frame base 2. At the other side 22 of the frame base 2, also, the panel frame 3 is pivotably attached to the frame base 2 with an arrangement similar to the above.

As shown in FIG. 1, the panel frame 3 is mainly provided with a display part (not shown) and a control part 33. Reference numeral 34 in FIG. 2 denotes a mounting area where the display part is mounted. Reference numeral 35 denotes a mounting area where the control part 33 is mounted. The display part has a video monitor, e.g. a liquid crystal monitor. The control part 33 has control knobs 36, a pushbutton 37, lamps (LEDs, not shown), switches, etc. The display part and the control part 33 are provided side by side on the panel frame 3.

Next, the angle adjusting means 4, which is a characteristic feature of the present invention, will be described. As shown in FIG. 1, the angle adjusting means 4 comprises mainly a pivoting part 40 provided on the center of the lower end of the panel frame 3 and a plate spring 41 provided as an engaging part on the inner side of the bottom 21 of the frame base 2. As illustrated in the figure, the pivoting part 40 projects from the center of the lower end of the panel frame 3 toward the bottom of the frame base 2. The pivoting part 40 is formed in the shape of an approximately half-disk centered at the center 80 (pivot point) of the outer plate 24. The pivoting part 40 has a plurality of notched grooves 42 formed on the outer periphery thereof. The pivoting part 40 illustrated in the figure has three notched grooves 42. The plate spring 41 is provided on the center of the inner side of the bottom 21 of the frame base 2 so that a distal-end 43 of the plate spring 41 is selectively engageable with any of the notched grooves 42. By changing the notched groove 42 to be engaged by the plate spring 41 from one to another, the tilt angle of the panel frame 3 with respect to the frame base 2 can be adjusted stepwise.

In an example shown in FIG. 1, the plate spring 41 is engaged in the central notched groove 42 of the three. In this case, the tilt angle of the panel frame 3 with respect to the frame base 2 is adjusted to zero degree.

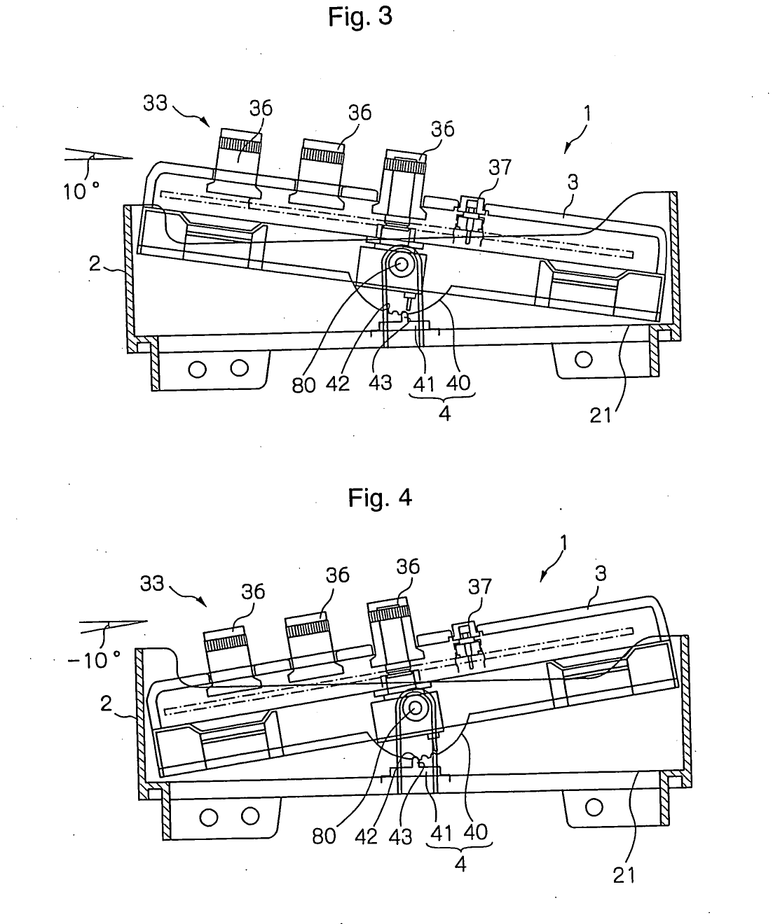

In an example shown in FIG. 3, the plate spring 41 is engaged in the right notched groove 42 of the three. In this case, the tilt angle of the panel frame 3 with respect to the frame base 2 is adjusted to 10 degrees. In FIG. 3, the left side of the panel frame 3 projects from the front of the frame base 2, and the right side of the panel frame 3 is recessed inside the frame base 2.

In an example shown in FIG. 4, the plate spring 41 is engaged in the left notched groove 42 of the three. In this case, the tilt angle of the panel frame 3 with respect to the frame base 2 is adjusted to −10 degrees. In FIG. 4, the right side of the panel frame 3 projects from the front of the frame base 2, and the left side of the panel frame 3 is recessed inside the frame base 2.

As has been stated above, the tilt angle of the panel frame 3 with respect to the frame base 2 can be adjusted stepwise by changing the notched groove 42 to be engaged by the distal end 43 of the plate spring 41 from one to another. When the user wants to adjust the display part to a desired angle, he or she presses the display part or the control part 33 with his or her hand to change the notched groove 42 to be engaged by the distal end 43 of the plate spring 41 from one to another. By doing so, the tilt angle of the panel frame 3 with respect to the frame base 2 can be stepwisely adjusted to a desired angle. Thus, the display part can be adjusted to a desired angle. Further, this angle adjustment allows both the display part and the control part 33 to be simultaneously adjusted as one unit in terms of the tilt angle with respect to the frame base 2. Accordingly, it is possible to improve convenience and controllability for the user.

It should be noted that the force with which the plate spring 41 engages any of the notched grooves 42 has been set larger than external force applied to the control part 33 when the user actuates the control part 33 (e.g. the force with which the user pushes the pushbutton 37 of the control part 33). Therefore, the tilt angle of the panel frame 3 with respect to the frame base 2 cannot be changed undesirably by external force applied to the control part 33 when the user actuates the control part 33.

In the foregoing embodiment, the pivoting part 40 is provided on the panel frame 3, and the plate spring 41 as an engaging part is provided on the frame base 2. However, the arrangement may be such that the pivoting part 40 is provided on the frame base 2, and the plate spring 41 is provided on the panel frame 3.

Further, the pivot shaft is not necessarily limited to the screw 14. For example, the pivot shaft may be an unthreaded shaft rod. In short, the pivot shaft may have any form, provided that it can pivotably attach the panel frame 3 to the frame base 2. However, it is possible to prevent backlash by using the screw 14 as the pivot shaft and engaging the threaded portion of the screw 14 into the tapped hole 26 through the insertion opening 25, the washer 6, the through-opening 32 and the bushing 5 as in the foregoing arrangement. Further, the pivot shaft may be provided on only one side 22 of the frame base 2.

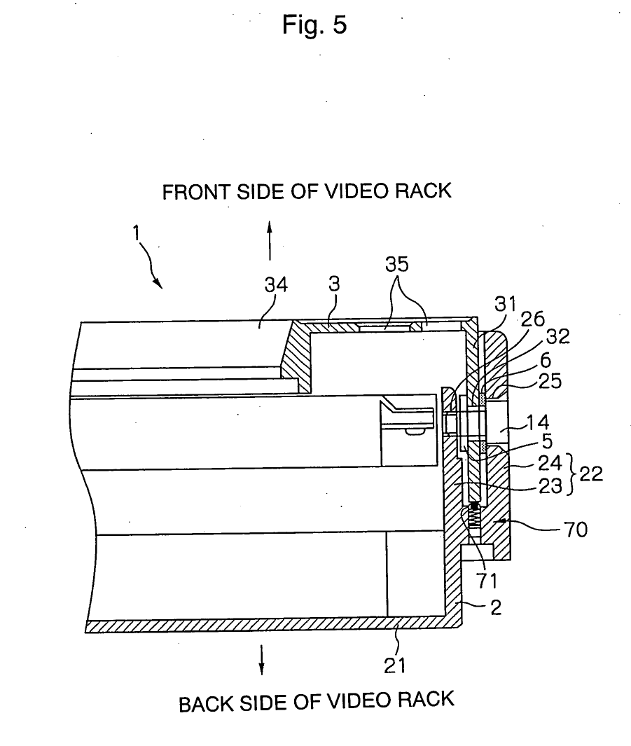

The engaging part may be a plunger, e.g. a ball plunger. FIG. 5 shows an example in which a ball plunger 70 is used as the engaging part. As shown in FIG. 5, the ball plunger 70 is provided on the frame base 2 so that a ball 71 positioned at the distal end of the ball plunger 70 is selectively engageable with any of the notched grooves 42 of the pivoting part 40 provided on the panel frame 3. It should be noted that the installation position and so forth of the ball plunger 70 are the same as in the case of the plate spring 41. Therefore, a specific description thereof is omitted.

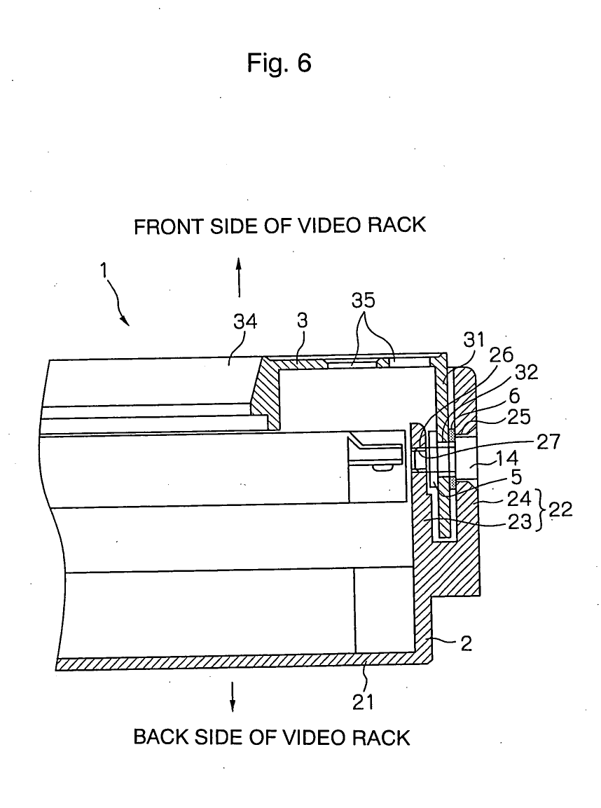

As shown in FIG. 6, the angle adjusting means 4 may comprise mainly the threaded portion 27 of the screw 14 and the tapped hole 26. As has been stated above, the screw 14 has its threaded portion 27 engaged in the tapped hole 26. Therefore, the force with which the threaded portion 27 of the screw 14 is engaged in the tapped hole 26 is set larger than external force applied to the control part 33 when the user actuates the control part 33 (e.g. the force with which the user pushes the pushbutton 37 of the control part 33). Consequently, the tilt angle of the panel frame 3 with respect to the frame base 2 cannot be changed undesirably by external force applied to the control part 33 when the user actuates the control part 33.

If the angle adjusting means 4 comprises the threaded portion 27 of the screw 14 and the tapped hole 26 as stated above, it is unnecessary to provide the pivoting part 40 and the plate spring 41 (see FIGS. 1 and 2) as in the foregoing arrangement, and hence possible to simplify the overall arrangement of the apparatus. In addition, the tilt angle of the panel frame 3 with respect to the frame base 2 can be adjusted steplessly, but not stepwise. Therefore, the user can finely adjust the tilt angle to a desired angle (e.g. 7 degrees).

1. A video panel apparatus comprising:
a frame base;
a panel frame pivotably provided on said frame base; and
angle adjusting means for adjusting a tilt angle of said panel frame with respect to said frame base.

2. A video panel apparatus according to claim 1, wherein said angle adjusting means includes a pivoting part having a plurality of notched grooves, and an engaging part selectively engageable with any of said notched grooves of said pivoting part, whereby said tilt angle is adjusted stepwise.

3. A video panel apparatus according to claim 2, wherein said pivoting part is provided on said frame base, and said engaging part is provided on said panel frame.

4. A video panel apparatus according to claim 2, wherein said pivoting part is provided on said panel frame, and said engaging part is provided on said frame base.

5. A video panel apparatus according to any one of claims 2 to 4, wherein said engaging part is formed at a distal end of a plate spring.

6. A video panel apparatus according to any one of claims 2 to 4, wherein said engaging part is formed at a distal end of a plunger.

7. A video panel apparatus according to any one of claims 1 to 6, wherein said panel frame is provided with a display part and a control part, so that both said display part and said control part are simultaneously adjusted as one unit in terms of a tilt angle with respect to said frame base when the tilt angle of said panel frame with respect to said frame base is adjusted by said angle adjusting means.

8. A video panel apparatus according to claim 7, wherein said display part has a video monitor.

9. A video panel apparatus according to claim 8, wherein said video monitor is a liquid crystal monitor.

10. A video panel apparatus according to any one of claims 7 to 9, wherein said control part has a pushbutton.

11. A video panel apparatus according to any one of claims 7 to 10, wherein force with which said engaging part engages any of said notched grooves has been set larger than external force applied to said control part when a user actuates said control part.

12. A video panel apparatus according to any one of claims 1 to 11, wherein said tilt angle adjusted by said angle adjusting means is in a range of from −10 degrees to 10 degrees.

13. A video panel apparatus according to claim 12, wherein said tilt angle adjusted by said angle adjusting means is zero degree.
